(19) United States
(12) Patent Application Publication
(10) Pub. No.: US 2003/0063946 A1
(43) Pub. Date: Apr. 3, 2003

(54) Disposable lotion applicator

(76) Inventors: Janet Williams, Soledad, CA (US); Betty J. Middleton, Visalia, CA (US); Winona H. Ennis, Visa., CA (US); Elsie Hope Brockman, Visalia, CA (US)

Correspondence Address: RYAN & ENGNATH, 8469 N. MILLBROOK AVENUE, SUITE 104, FRESNO, CA, 93720, US

(21) Appl. No.: 10/243,439

(22) Filed: Sep. 11, 2002

Related U.S. Application Data
(63) Continuation-in-part of application No. 09/737,421, filed on Dec. 18, 2000, now abandoned.

(51) Int. Cl. B43K 5/00

(52) U.S. Cl. 401/261; 15/208

(57) ABSTRACT

A disposable lotion applicator having a generally flat, elongated body member made out of an absorbent, flexible material that is suitable for receiving and retaining lotion. Lotion can be pre-applied to the applicator or the user of the applicator can apply lotion of their choice. The user of the applicator grasps the ends thereof to rub lotion across the hard-to-reach areas of their body. The applicator can be provided with handles at the ends of the body member that are integral to the body member for grasping the applicator.

### CROSS-REFERENCE TO RELATED APPLICATIONS

This application is a continuing application of U.S. patent application Ser. No. 09/737,421 filed Dec. 18, 2000, which was the subject of Disclosure Document No. 471,015 filed Mar. 17, 2000.

### BACKGROUND OF THE INVENTION

A. Field of the Invention

The present invention relates to elongated non-woven disposable material applicators for applying lotion, oil, creams or medication to hard-to-reach locations on a body. More specifically, the lotion applicators of the present invention relates to such apparatuses that are disposable and are made from an elongated absorbent non-woven material similar to baby wipes or face-wipes that can receive lotion.

B. Background

People commonly place various types of lotions, creams and other substances on their body for many purposes, including suntan lotion to avoid damaging their skin from exposure to the sun and moisturizing lotion to avoid or cure dry skin. To be fully effective, it is necessary to place the lotions or creams on all parts of the body on which it is necessary to protect or treat. As is well known, some areas of the body are very difficult, if not impossible, for a person to reach. On such area is the middle of the back from the shoulders down to nearly the waist. Other areas, while reachable, can require some effort to be able to effectively place the lotion or cream thereon. For people who are less flexible than average or who are physically challenged in some way, there can be many areas of the body that are difficult or not even possible to reach. As a result of the inability or difficulty in reaching these areas of the body it is not uncommon that an effective amount of lotion or cream is not applied. As would be expected, these areas of the body then do not improve or risk damage. For instance, the failure to place an effective amount of suntan lotion on the middle of the back or other hard-to-reach areas can result in a sunburn that can be very painful and perhaps a danger to a person's health.

To overcome the difficulties in reaching the hard-to-reach areas of the body people often resort to many different types of devices or methods to place the lotion or cream on these areas. The most common method to overcome the problem is to have another person place the lotion or cream on the hard to reach area. Naturally, if another person is not available, the is not possible. Even if other persons are available, many people are uncomfortable with the intimacy of having another person rubbing lotion or cream on their body. The person rubbing the lotion or cream may also feel uncomfortable, which can result in a less than effective amount of lotion or cream being applied. To get around the requirement of having another person apply the lotion or cream, several applicator apparatuses have been developed to allow the individual wanting the lotion or cream to place the substance on his or her body by themselves.

One such apparatus is disclosed in U.S. Pat. No. 5,736,213 to Meier, which provides for an applicator for lotions that comprised an elongated body made of non-absorbent material with elastic handles on the ends of the body. The apparatus the Meier patent utilizes a non-absorbent material, preferably a material such as polyvinylchloride, to prevent the absorption of the lotion into the apparatus and to provide for long life. Because this applicator utilizes a non-absorbent material, lotion can drip or run off the applicator while trying to apply the lotion to the body and the applicator is not suitable for pre-moisturizing with lotion. As such, this apparatus is intended for re-use and not as a single use, disposable product such as disclosed in the present invention. U.S. Pat. No. Des. 393,102, also to Meier, discloses a design for an elongated lotion applicator having handles attached to the ends thereof. This design patent disclosed a strap-like apparatus having a relatively thick cross-sectional area for the body portion of the applicator.

Other patents also disclose lotion applicators of various configurations. For instance, U.S. Pat. No. 4,861,180 to Adams, U.S. Pat. No. 4,396,028 to Waggoner, U.S. Pat. No. 3,568,237 to Rhodes, U.S. Pat. No. Des. 271,624 to Paulson, German Patent DE 28 52 490 A1 and UK Patent GB 2 046 596 to Gollamali all describe lotion applicators that comprise a handle portion and a head portion to allow the person utilizing the devices to reach behind their back or to other hard-to-reach places in order to apply lotion. Several of the devices store lotion inside the handle portion that flows to the head portion for application to the human body. The Waggoner and Rhodes patents require the user to place the lotion directly on the head portion. All of these devises are configured to be non-disposable devices.

None of the aforementioned devices provides for lotion applicators that are made out of an absorbent, disposable material that can be used to place lotion on hard-to-reach areas of the body. To the inventors' knowledge, no such devices exist. As a result, most people either fail to place the needed lotion on those areas or have to rely on the assistance of another person to cover the hard-to-reach areas. Another problem is sanitation, with the present applicators each person should have their own device or they would need to be cleaned before another could use the applicator. If a person is at the beach or camping this could be very inconvenient or impossible. Another problem would be that is a person had more than one type of lotion or cream to apply they would have to wash or disinfect it between each application. Therefore, what is needed are inexpensive, effective and easy to use lotion applicators that are made out of material that can absorb lotion and yet be disposable when the person is done placing lotion on their body. Ideally, such devises should be sufficiently compact or able to be compacted such that they fit into an easy to carry container for travel use or use at the beach or other outdoor locations.

### SUMMARY OF THE INVENTION

The disposable lotion applicators of the present invention solve the problems identified above. Specifically, the present invention discloses applicators that allow a person to place lotion on all the hard-to-reach areas of their body without requiring the assistance of another person or having to utilize a handle/head device. The applicators of the present invention are flexible and sufficiently compact such that they are suitable for placement in a small, easily carried package that could contain one or more of the lotion applicators, either with or without lotion already on the applicators. As such, the disposable lotion applicators of the present invention are relatively inexpensive and easy to use devices that can effectively place lotion on the hard-to-reach areas of a person's body.

The disposable lotion applicators of the present invention generally comprise substantially flat, elongated body members that have a first end, and opposing second end, a top surface and a bottom surface. The body members are made from flexible and generally absorbent non-woven material suitable for receiving and retaining lotion, such as is used for baby wipes or face wipes. The lotion applicators can have a handle that is cut into the body members at each end such that it is integral to the body member. This would insure that the entire applicator would remain disposable.

In one configuration of the disposable lotion applicators of the present invention, the body members are twenty to thirty-six inches long, two to six inches wide and 0.004 inch to one-half inch thick. The lotion applicators can be provided in either a dry condition that is suitable for the user to place the lotion he or she desires on the applicators or it can be provided in a “pre-moistened” condition that has one or more lotions already applied thereto. Various types of lotions are suitable for use with applicators of the present invention. These lotions include, for instance, suntan lotion, sun screen, moisturizing lotion, insect repellant, oils, medicated ointments and the like to allow persons to apply the lotion to all parts of their body, including the hard-to-reach areas.

Accordingly, the primary objective of the present invention is to provide a disposable lotion applicators that are configured such that they can be used by a person to place lotion on the hard-to-reach areas of his or her body.

It is also an important objective of the present invention to provide disposable lotion applicators that are absorbent so that lotions can be pre-applied to the applicators at time of packaging or they can be packaged dry so the user can apply the lotion of his or her choice prior to use. This allows those persons who need to apply prescription salves or ointment to their body to place the material on the dry applicators.

Another important objective of the present invention is to provide disposable lotion applicators that are sufficiently compact in size that one or more of the applicators can fit into easy to carry packages suitable for carrying in a purse, bag, pocket or other small areas.

Another important objective of the present invention is to provide disposable lotion applicators that have handles integrated at the ends thereof so the user has greater control of the device. This would benefit handicapped or physically impaired individuals.

The above and other objectives of the present invention will be explained in greater detail by reference to the attached figures and description of the preferred embodiments which follows. As set forth herein, the present invention resides in the novel features of form, construction, mode of operation and combination of parts presently described and understood by the claims.

### BRIEF DESCRIPTION OF THE DRAWINGS

In the drawings which illustrate the best modes presently contemplated for carrying out the present invention:

FIG. 1 is a top view of a disposable lotion applicator of the present invention;

FIG. 2 is top view of another configuration for the disposable lotion applicator of the present invention;

FIG. 3 is a side view of the applicator in FIG. 2; and

FIG. 4 is a top view of a disposable lotion applicator of the present invention having handles integral with each end of the applicator.

### DETAILED DESCRIPTION OF THE PREFERRED EMBODIMENTS

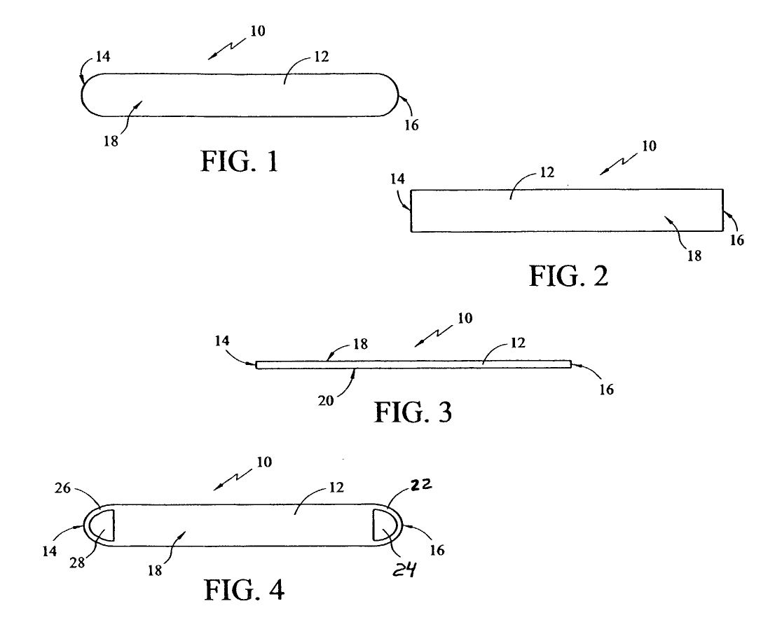

With reference to the figures where like elements have been given like numerical designations to facilitate the reader's understanding of the present invention, and particularly with reference to the embodiments of the present invention illustrated in FIGS. 1 through 4, the preferred embodiment of the present invention is set forth below. The disposable lotion applicator of the present invention, designated generally as 10, primarily comprises a substantially flat, elongated body member 12 having first end 14 and opposing second end 16 and a top surface 18 and bottom surface 20. The body member 12 should be made out of a material that is flexible, so that it can follow the contours of a person's body during use (as described below) and can be folded for storage when packaged.

The material for body member 12 should be generally absorbent so that it is suitable for receiving and retaining lotion thereon. A disposable non-woven material is preferred. The material for body member 12 must be of the type that is sufficiently strong that during use it is not easily torn by the stretching and rubbing action that will take place. The material for body member 12 should be substantially smooth and relatively soft in that it does not have any edges or protrusions that will scratch or otherwise undesirably rub the user and that it will be comfortable rubbing across or against the bare skin of the person utilizing applicator 10. One material that can be utilized for body member 12, which is commonly used for baby wipes and hand/face wipes, is a thin non-woven material that, despite its thinness, is substantially tear resistant. The non-woven material has been found to be generally smooth and soft enough for use against the bare human skin. Other materials, including various paper materials, can also be suitable for use for body member 12. Because the lotion applicator 10 is intended to be disposable, the material chosen for body member 12 should, in addition to the characteristics described above, be inexpensive to make and/or the type that readily breaks down or decomposes so as not to create problems for landfills or other methods of refuse handling.

In one embodiment of the disposable lotion applicator 10 of the present invention, shown in FIGS. 1 and 2, the first 14 and second 16 ends of body member 12 do not comprise any special configuration. The user of the lotion applicator 10 merely grabs onto the ends 14 and 16 and moves the applicator 10 across the portion of the body they desire to place lotion on (i.e., the back or bottom of feet, etc.). In an another embodiment of the present invention, one or both of ends 14 and 16 comprise handles 22. The use of handles 22 has the advantage that the user can grasp the handles 22 to apply lotion from the body member 12 and not get lotion on their hands. As shown in FIG. 4, handles 22 can be configured to be integral with body member 12 by providing an opening 24 near ends 14 and 16 that is suitable for the person to place their hand or one or more fingers therein for gripping applicator 10.

As set forth above, the material for body member 12 is generally absorbent so the lotion can be retained on body member 12 during use. Because the applicator 10 utilizes an absorbent body member 12, the applicator 10 can be provided in either a dry condition, ready to receive lotion, or it can be provided already moistened with one or more types of lotion. The dry condition allows the user to selectively place the desired lotion on the applicator 10 and apply the lotion to his or her body. If, instead, the applicator 10 is already saturated or partially saturated with lotion, the user merely has to pull or remove the applicator 10 from its container or package and use it to spread the lotion on the desired areas and then dispose.

The applicator 10 of the present invention should be sized and configured such that it can be used by a person to apply lotion to all parts of their body. The elongated shape of body member 12 is suitable for rubbing lotion on a person's back, legs, feet and other places that may be hard to reach. The inventors have found that a body member 12 having a length of twenty to thirty-six inches long and a width of two to six inches wide provides an applicator that is easy to use to cover all the hard-to-reach areas of the body. Although the body member 12 could be shorter or longer, if it is too short it could be difficult to grasp in both hands and rub across the back or the bottoms of one's feet and if it is too long material would be wasted and the costs would be unnecessarily higher. If the body member 12 is too narrow it could be more difficult to effectively rub the lotion onto the body and if it is too wide there would be wasted material. Ideally, the thickness of body member 12 would be approximately 0.004 to 0.5 inches thick. The narrow thickness of body member 12 allows it to be easily folded into a container and then easily removed therefrom for use to spread lotion.

Various types of lotions are suitable for use with applicator 10 of the present invention. For instance, suntan lotion or sun screen, moisturizing lotion, insect repellant, oils, medicated ointments and others can be more easily applied with the lotion applicator 10. Use of the applicator 10 is generally beneficial for most all people due to the inability to reach certain areas of the body. For some people, such as those who are injured, handicapped, pregnant or obese, the applicator 10 of the present invention is even more useful due to the fact that more areas of the body may be hard to reach with their hand (the typical way of putting lotion on the body).

While there is shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use.

What is claimed is:

1. A disposable lotion applicator, comprising:
a substantially flat, elongated body member having a first end, an opposing second end, a top surface and a bottom surface, said body member made from a flexible and generally absorbent material suitable for receiving and retaining lotion thereon.

2. The disposable lotion applicator according to claim 1, wherein said generally absorbent material is non-woven cloth.

3. The disposable lotion applicator according to claim 1 further comprising a handle at each of said first end and said second end of said body member.

4. The disposable lotion applicator according to claim 3, wherein said handle is integral to said body member.

5. The disposable lotion applicator according to claim 1, wherein said applicator has lotion applied to said body member.

6. The disposable lotion applicator according to claim 1, said body member is twenty to thirty-six inches in length.

7. The disposable lotion applicator according to claim 1, wherein said body member is two to six inches in width.

8. The disposable lotion applicator according to claim 1, wherein said body member is 0.004 to 0.5 inch in thickness.

9. A disposable lotion applicator, comprising:
a substantially flat, elongated body member having a first end, an opposing second end, a top surface and a bottom surface, said body member made from a flexible and generally absorbent material suitable for receiving and retaining lotion thereon; and
an integral handle at each of said first end and said second end of said body member.

10. The disposable lotion applicator according to claim 9, wherein said generally absorbent material is non-woven cloth.

11. The disposable lotion applicator according to claim 10, wherein said applicator has lotion applied to said body member.

12. The disposable lotion applicator according to claim 9, wherein said applicator has lotion applied to said body member.

13. The disposable lotion applicator according to claim 9, said body member is twenty to thirty-six inches in length, two to six inches in width and 0.004 to 0.5 inch in thickness.

14. A disposable lotion applicator, comprising:
a substantially flat, elongated body member having a first end, an opposing second end, a top surface and a bottom surface, said body member made from a flexible and generally absorbent non-woven cloth suitable for receiving and retaining lotion thereon; and
an integral handle at each of said first end and said second end of said body member, said handle comprising an opening in said body member.

15. The disposable lotion applicator according to claim 14, wherein said applicator has lotion applied to said body member.
